(19) United States
(12) Patent Application Publication
(10) Pub. No.: US 2024/0142919 A1
(43) Pub. Date: May 2, 2024

(54) SERVER, ELECTRONIC APPARATUS FOR CONTROLLING HOME APPLIANCE AND CONTROL METHOD THEREOF

(71) Applicant: SAMSUNG ELECTRONICS CO., LTD., Suwon-si (KR)

(72) Inventors: Yunkyeong LEE, Suwon-si (KR); Jaewoong KIM, Suwon-si (KR); Juneok AHN, Suwon-si (KR); Useong JANG, Suwon-si (KR)

(73) Assignee: SAMSUNG ELECTRONICS CO., LTD., Suwon-si (KR)

(21) Appl. No.: 18/241,677

(22) Filed: Sep. 1, 2023

Related U.S. Application Data
(63) Continuation of application No. PCT/KR23/11373, filed on Aug. 2, 2023.

(30) Foreign Application Priority Data
Oct. 26, 2022 (KR) 10-2022-0139485

(51) Int. Cl. G05B 13/02; G06N 3/08; G16Y 10/75; G16Y 20/20; H04L 12/28

(52) U.S. Cl. CPC G05B 13/027; G06N 3/08; G16Y 10/75; G16Y 20/20; H04L 12/282; H04L 2012/285

(57) ABSTRACT

A server includes a communication interface; and at least one processor operatively connected to the communication interface and configured to: identify, based on use information received through the communication interface and related to at least one from among a plurality of electronic apparatuses, a first electronic apparatus to be used after from among the plurality of electronic apparatuses, and control the communication interface to transmit, to the first electronic apparatus from among the plurality of electronic apparatuses, a first control signal for controlling the first electronic apparatus.

### CROSS-REFERENCE TO RELATED APPLICATIONS

This application is a by-pass continuation of International Application No. PCT/KR2023/011373, filed on Aug. 2, 2023, which is based on and claims priority to Korean Patent Application No. 10-2022-0139485, filed on Oct. 26, 2022, in the Korean Intellectual Property Office, the disclosures of each which are incorporated by reference herein in their entireties.

### BACKGROUND

### 1. Field

The disclosure relates to a server, an electronic apparatus, and control methods thereof, and more particularly to a server and an electronic apparatus for controlling a home appliance, and control methods thereof.

### 2. Description of Related Art

With developments in electronic technology, electronic apparatuses of various types are being developed. Specifically, recently, most of the electronic apparatuses are being supplied as internet of things (IoT) devices connected to the internet.

With the supply of IoT devices, various methods for enhancing user convenience are being developed.

### SUMMARY

According to an aspect of the disclosure, a server includes: a communication interface; and at least one processor operatively connected to the communication interface and configured to: identify, based on use information received through the communication interface and related to at least one from among a plurality of electronic apparatuses, a first electronic apparatus to be used after from among the plurality of electronic apparatuses, and control the communication interface to transmit, to the first electronic apparatus from among the plurality of electronic apparatuses, a first control signal for controlling the first electronic apparatus.

The server may further include: a memory configured to store a neural network model, the at least one processor may be operatively connected to the memory and may be further configured to identify the first electronic apparatus by inputting the use information to the neural network model, and the neural network model may be trained using patterns of use by a user of the plurality of electronic apparatuses.

The at least one processor may be further configured to: identify a first control operation of the first electronic apparatus based on the use information, and control the communication interface to transmit the first control signal to the first electronic apparatus based on the first control operation.

The at least one processor may be further configured to: identify a first control operation of the first electronic apparatus based on the use information, based on the first control operation being a single first control operation, control the communication interface to transmit the first control signal to the first electronic apparatus based on the single first control operation, and based on the first control operation being a plurality of first control operations, control the communication interface to transmit a signal to display a screen on a display of the first electronic apparatus, wherein the screen is configured to guide a user through the plurality of first control operations.

The at least one processor may be further configured to: identify, based on the use information, at least two electronic apparatuses to be used after from among the plurality of electronic apparatuses, wherein the at least two electronic apparatuses include the first electronic apparatus, and control, based on the at least two electronic apparatuses including a pre-set apparatus, the communication interface to transmit to the pre-set apparatus a second control signal.

The at least one processor may be further configured to: identify, based on the use information, a second control operation of the pre-set apparatus, identify a third control operation of the pre-set apparatus necessary for performing the second control operation, and control the communication interface to transmit the second control signal to the pre-set apparatus based on at least one of the second control operation or the third control operation.

The at least one processor may be further configured to: identify a time-point at which the pre-set apparatus is to operate based on at least one from among an operation state of the pre-set apparatus, a second control operation, or a third control operation, and control the communication interface to transmit information about the time-point at which the pre-set apparatus is to operate to the pre-set apparatus.

The at least one processor may be further configured to control the communication interface to transmit a signal to guide an operation of the pre-set apparatus to an electronic apparatus corresponding to the time-point at which the pre-set apparatus is to operate among the at least two electronic apparatuses.

The server may include an Internet of Things server configured to manage operations of the plurality of electronic apparatuses.

According to an aspect of the disclosure, a method of controlling a server, includes: receiving use information related to at least one from among a plurality of electronic apparatuses; identifying, based on the use information, a first electronic apparatus to be used after from among the plurality of electronic apparatuses; and transmitting, to the first electronic apparatus, a first control signal for controlling the first electronic apparatus.

The identifying may include identifying the first electronic apparatus by inputting the use information to a neural network model, and the neural network model may be trained using patterns of use of a user of the plurality of electronic apparatuses.

The method may further include identifying a first control operation of the first electronic apparatus based on the use information, and the transmitting may include transmitting the first control signal to the first electronic apparatus based on the first control operation.

The method may further include identifying a first control operation of the first electronic apparatus based on the use information, and the transmitting may include: transmitting, based on the first control operation being a single first control operation, the first control signal to the first electronic apparatus based on the first control operation, and transmitting, based on the first control operation being a plurality of first control operations, a signal causing a screen to be displayed on a display of the first electronic apparatus, wherein the screen is configured to guide a user through the plurality of first control operations.

The identifying may include identifying, based on the use information, at least two electronic apparatuses to be used after from among the plurality of electronic apparatuses, wherein the at least two electronic apparatuses include the first electronic apparatus, and the method may further include, based on the at least two electronic apparatuses including a pre-set apparatus, transmitting, to the pre-set apparatus, a second control signal for controlling the pre-set apparatus.

The transmitting the second control signal may include: identifying, based on the use information, a second control operation of the pre-set apparatus, identifying a third control operation of the pre-set apparatus necessary for performing the second control operation, and transmitting the second control signal to the pre-set apparatus based on at least one of the second control operation or the third control operation.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic system according to one or more embodiments;

FIG. 2 is a block diagram illustrating a configuration of a server according to one or more embodiments;

FIG. 3 is a block diagram illustrating a configuration of an electronic apparatus according to one or more embodiments;

FIG. 4 is a block diagram illustrating a detailed configuration of an electronic apparatus according to one or more embodiments;

FIG. 5 is a diagram illustrating an operation of identifying an apparatus to be used after according to one or more embodiments;

FIG. 6 is a sequence diagram illustrating an operation of controlling an apparatus to be used after according to one or more embodiments;

FIG. 7 and FIG. 8 are diagrams illustrating a screen guiding of an apparatus to be used after according to one or more embodiments;

FIG. 9 is a diagram illustrating an operation of when a pre-set apparatus is included among apparatuses to be used after according to one or more embodiments;

FIG. 10 and FIG. 11 are diagrams illustrating a method of using a neural network model according to one or more embodiments;

FIG. 12 is a sequence diagram illustrating an operation of when a pre-set apparatus is included among apparatuses to be used after according to one or more embodiments;

FIG. 13 and FIG. 14 are diagrams illustrating a method of guiding a preparation operation of a pre-set apparatus according to one or more embodiments;

FIG. 15 is a diagram illustrating a guide of a user terminal apparatus according to one or more embodiments;

FIG. 16 is a flowchart illustrating a control method of a server according to one or more embodiments; and

FIG. 17 is a flowchart illustrating a control method of an electronic apparatus according to one or more embodiments.

### DETAILED DESCRIPTION

The example embodiments of the present disclosure may be diversely modified. Accordingly, specific example embodiments are illustrated in the drawings and are described in detail in the detailed description. However, it is to be understood that the present disclosure is not limited to a specific example embodiment, but includes all modifications, equivalents, and substitutions without departing from the scope and spirit of the present disclosure. Also, well-known functions or constructions are not described in detail since they would obscure the disclosure with unnecessary detail.

An object of the disclosure is in providing a server and an electronic apparatus for identifying a home appliance to be used after based on a use pattern of a user and controlling the identified home appliance, and control methods thereof.

The disclosure will be described in detail below with reference to the accompanying drawings.

Terms used in describing one or more embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have,” “may have,” “include,” “may include,” or the like are used to designate a presence of a corresponding characteristic (e.g., elements such as numerical value, function, operation, or component), and not to preclude a presence or a possibility of additional characteristics.

The expression “at least one of A or B” is to be understood as indicating any one of only “A,” only “B,” or both “A and B.”

Expressions such as “first,” “second,” “1st,” “2nd,” and so on used herein may be used to refer to various elements regardless of order and/or importance. Further, it should be noted that the expressions are merely used to distinguish an element from another element and not to limit the relevant elements.

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

In this disclosure, the term “user” may refer to a person using an electronic apparatus or an apparatus (e.g., artificial intelligence electronic apparatus) using an electronic apparatus.

In this disclosure, the terms “device” and “apparatus” are interchangeably used.

Various embodiments of the disclosure will be described in greater detail below with reference to the accompanied drawings.

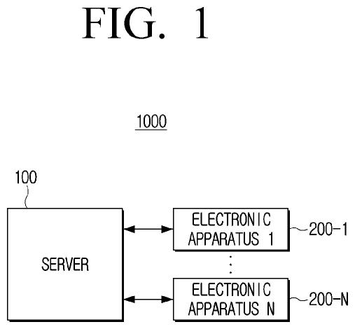

FIG. 1 is a block diagram illustrating an electronic system 1000 according to one or more embodiments. As shown in FIG. 1, the electronic system 1000 may include a server 100 and a plurality of electronic apparatuses 200-1 to 200-N.

The server 100 may be an Internet of Things (IoT) server that manages operations of the plurality of electronic apparatuses 200-1 to 200-N.

The server 100 may identify, based on use information about at least one from among the plurality of electronic apparatuses 200-1 to 200-N being received, one from among the plurality of electronic apparatuses 200-1 to 200-N as an apparatus to be used after based on the use information. For example, the server 100 may identify, based on information that a refrigerator compartment has been opened and closed being received from a refrigerator due to the refrigerator compartment of the refrigerator being opened and closed, an oven as the apparatus to be used after.

The server 100 may transmit, based on one from among the plurality of electronic apparatuses 200-1 to 200-N being identified as the apparatus to be used after, a first control signal for controlling one from among the plurality of electronic apparatuses 200-1 to 200-N as one from among the plurality of electronic apparatuses 200-1 to 200-N. For example, the server 100 may identify, based on information that the refrigerator compartment has been opened and closed being received from the refrigerator, the oven as the apparatus to be used after, and transmit the first control signal for pre-heating the oven to the oven.

The plurality of electronic apparatuses 200-1 to 200-N may be IoT devices, for example, home appliances. Specifically, the plurality of electronic apparatuses 200-1 to 200-N may be kitchen devices capable of internet connection, and examples thereof may include the refrigerator, a freezer, a dish washer, the oven, a microwave, an induction heating surface, a water purifier, and the like.

The plurality of electronic apparatuses 200-1 to 200-N may be in a state registered in the server 100. For example, each of the electronic apparatuses 200-1 to 200-N may transmit to the server 100 a state of use or associated information if the state of use is changed.

Each of the electronic apparatuses 200-1 to 200-N may operate based on a control signal if the control signal is received from the server 100.

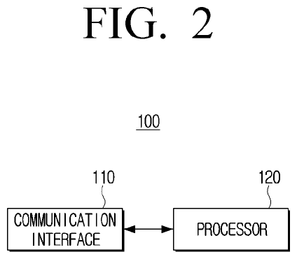

FIG. 2 is a block diagram illustrating a configuration of the server 100 according to one or more embodiments. Referring to FIG. 2, the server 100 may include a communication interface 110 and at least one processor 120.

The communication interface 110 may be a configuration that performs communication with external apparatuses of various types according to communication methods of various types. For example, the server 100 may perform communication with each of the electronic apparatuses 200-1 to 200-N through the communication interface 110.

The communication interface 110 may include a Wi-Fi module, a Bluetooth module, an infrared communication module, a wireless communication module, and the like. Here, each communication module may be realized in at least one hardware chip form.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and after communicatively connecting using the same, various information may be transmitted and received. The infrared communication module may perform communication according to an infrared communication (Infrared Data Association (IrDA)) technology of transmitting data wirelessly in short range by using infrared rays present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

Alternatively, the communication interface 110 may include a wired communication interface such as, for example, and without limitation, HDMI, DP, Thunderbolt, USB, RGB, D-SUB, DVI, and the like.

In addition thereto, the communication interface 110 may include at least one from among wired communication modules that perform communication using a local area network (LAN) module, an Ethernet module, or a pair cable, a coaxial cable or an optical fiber cable, or the like.

The processor 120 may control the overall operation of the server 100. Specifically, the processor 120 may control the overall operation of the server 100 by being connected with each configuration of the server 100. For example, the processor 120 may be connected with various components such as the communication interface 110, a memory, and the like and control an operation of the server 100.

Herein, the term “processor” may refer to one processor or a plurality of processors perform operations. At least one processor 120 may include at least one from among a central processing unit (CPU), a graphics processing unit (GPU), an accelerated processing unit (APU), a many integrated core (MIC), a neural processing unit (NPU), a hardware accelerator, or a machine learning accelerator. The at least one processor 120 may control one or a random combination from among other elements of the server 100, and perform an operation associated with communication or data processing. The at least one processor 120 may execute at least one program or instruction stored in the memory. For example, the at least one processor 120 may perform, by executing at least one instruction stored in the memory, a method according to one or more embodiments of the disclosure.

When a method according to one or more embodiments of the disclosure include a plurality of operations, the plurality of operations may be performed by one processor, or performed by a plurality of processors. For example, when a first operation, a second operation, and a third operation are performed by a method according to one or more embodiments, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The at least one processor 120 may be realized as a single core processor that includes one core, or as at least one multicore processor that includes a plurality of cores (e.g., a homogeneous multicore or a heterogeneous multicore). If the at least one processor 120 is realized as a multicore processor, each of the cores included in the multicore processor may include a memory inside the processor such as a cache memory and an on-chip memory, and a common cache shared by the plurality of cores may be included in the multicore processor. In addition, each of the cores (or a portion from among the plurality of cores) included in the multicore processor may independently read and perform a program command for realizing a method according to one or more embodiments, or read and perform a program command for realizing a method according to one or more embodiments of the disclosure due to a whole (or a portion) of the plurality of cores being interconnected.

When a method according to one or more embodiments of the disclosure include a plurality of operations, the plurality of operations may be performed by one core from among the plurality of cores or performed by the plurality of cores included in the multicore processor. For example, when a first operation, a second operation, and a third operation are performed by a method according to one or more embodiments, the first operation, the second operation, and the third operation may all be performed by a first core included in the multicore processor, or the first operation and the second operation may be performed by the first core included in the multicore processor and the third operation may be performed by a second core included in the multicore processor.

According to one or more embodiments, the at least one processor 120 may refer to a system on chip (SoC), a single core processor, or a multicore processor in which the at least one processor and other electronic components are integrated or a core included in the single core processor or the multicore processor, and the core herein may be realized as the CPU, the GPU, the APU, the MIC, the NPU, the hardware accelerator, the machine learning accelerator, or the like, but is not limited to the one or more embodiments of the disclosure. However, for convenience of description, an operation of the server 100 will be described below using the expression “processor 120.”

The processor 120 may control, based on use information about at least one from among the plurality of electronic apparatuses 200-1 to 200-N being received through the communication interface 110, the communication interface 110 to identify, one from among the plurality of electronic apparatuses 200-1 to 200-N as the apparatus to be used after based on the use information, and transmit the first control signal for controlling one from among the plurality of electronic apparatuses 200-1 to 200-N to the one from among the plurality of electronic apparatuses 200-1 to 200-N.

For example, the processor 120 may identify, based on information that the refrigerator compartment has been opened and closed being received from the refrigerator due to the refrigerator compartment of the refrigerator being opened and closed, the oven as the apparatus to be used after, and transmit the first control signal for pre-heating the oven to the oven. Alternatively, the processor 120 may identify, based on information that the refrigerator compartment has been opened and closed being received from the refrigerator, and information that the induction heating surface has been turned on being received from the induction heating surface, a hood as the apparatus to be used after, and transmit the first control signal for turning-on the hood to the hood.

However, the above is not limited thereto, and the processor 120 may identify, based on use information about at least one from among the plurality of electronic apparatuses 200-1 to 200-N being received through the communication interface 110, at least two electronic apparatuses from among the plurality of electronic apparatuses 200-1 to 200-N as apparatuses to be used after based on the use information. In this case, the processor 120 may transmit a control signal that controls an electronic apparatus that transmitted use information to display a guide screen for selecting one from among at least two electronic apparatuses to the electronic apparatus that transmitted the use information. For example, the processor 120 may identify, based on information that the refrigerator compartment has been opened and closed being received from the refrigerator due to the refrigerator compartment of the refrigerator being opened and closed, an oven and a hood as apparatuses to be used after. In this case, the processor 120 may transmit a control signal that controls to display a guide screen for selecting one from among the oven and the hood to the refrigerator.

The server 100 may further include a memory storing a neural network model, and the processor 120 may identify one from among the plurality of electronic apparatuses 200-1 to 200-N by inputting use information to the neural network model. Here, the neural network model may be a model that learned the use pattern of the user for the plurality of electronic apparatuses 200-1 to 200-N. In an example, the neural network model may learn the use pattern such as pre-heating the oven for a pre-set time after the user opens and closes the refrigerator compartment of the refrigerator.

However, the above is not limited thereto, and the processor 120 may identify one from among the plurality of electronic apparatuses 200-1 to 200-N by inputting the use information to a rule-based model and not the neural network model. Here, the rule-based model may be a model generated based on the use pattern of the user.

The processor 120 may identify one from among the plurality of electronic apparatuses 200-1 to 200-N and a first control operation of one from among the plurality of electronic apparatuses 200-1 to 200-N based on the use information, and control the communication interface 110 to transmit the first control signal to the one from among the plurality of electronic apparatuses 200-1 to 200-N based on the first control operation.

For example, the processor 120 may identify the oven as the apparatus to be used after when the refrigerator compartment of the refrigerator is opened and closed, and identify a pre-heat operation of the oven as the first control operation.

The processor 120 may control, based on the first control operation being a control operation of one from among the plurality of electronic apparatuses 200-1 to 200-N, the communication interface 110 to transmit the first control signal to one from among the plurality of electronic apparatuses 200-1 to 200-N based on the first control operation, and control, based on the first control operation being a control operation of a plurality of electronic apparatus from among the plurality of electronic apparatuses 200-1 to 200-N, the communication interface 110 to transmit a signal causing a screen that guides a plurality of first control operations to be displayed to one from among the plurality of electronic apparatuses 200-1 to 200-N.

For example, the processor 120 may transmit, based on identifying the microwave as the apparatus to be used after when the refrigerator compartment of the refrigerator is opened and closed and a defrost operation of the microwave being identified as the first control operation, the first control signal to the oven based on the defrost operation, and transmit, based on identifying the microwave as the apparatus to be used after and the defrost operation and a deodorization operation of the microwave being identified as the first control operation, a signal controlling for a screen that guides the defrost operation and the deodorization operation to be displayed to the microwave. In this case, the microwave may display a guide screen and perform an operation corresponding to a user selection.

However, the above is not limited thereto, and the processor 120 may control, based on the plurality of first control operations being identified, the communication interface 110 to transmit to the apparatus that transmitted the use information and not the apparatus to be used after. In the above-described example, the processor 120 may transmit the signal controlling for the screen that guides the defrost operation and the deodorization operation to be displayed to the refrigerator and not the microwave. In this case, the refrigerator may display the guide screen and transmit, based on a user command selecting one from among the defrost operation and the deodorization operation being received, the user command to the server 100, and the server 100 may transmit the user command to the microwave. Alternatively, the refrigerator may transmit the user command directly to the microwave.

The processor 120 may identify at least a portion from among the plurality of electronic apparatuses 200-1 to 200-N as apparatuses to be used after based on the use information, and control the communication interface 110 to transmit, based on a pre-set apparatus being included among apparatuses of at least a portion, a second control signal for controlling the pre-set apparatus to the pre-set apparatus.

The processor 120 may identify a second control operation of the pre-set apparatus based on the use information, identify a third control operation of the pre-set apparatus necessary for performing the second control operation, and control the communication interface 110 to transmit the second control signal to the pre-set apparatus based on at least one from among the second control operation or the third control operation.

For example, the processor 120 may identify, based on the refrigerator compartment of the refrigerator being opened and closed, the induction heating surface being turned-on, and the refrigerator compartment of the refrigerator being opened and closed, the hood, the induction heating surface, and the oven as apparatuses to be sequentially used after. The processor 120 may identify the oven from among the hood, the induction heating surface, and the oven as the pre-set apparatus, identify a heat operation as the second control operation, identify the pre-heat operation of the oven necessary for performing the heat operation, and control the communication interface 110 to transmit the second control signal to the oven based on the pre-heat operation and the heat operation. Here, the heat operation may refer to an operation that places a food product in the oven and cooks the food product with a heat source, and the pre-heat operation may be an operation that may raise a temperature of the heat source of the oven without the food product prior to the heat operation.

The processor 120 may identify a time-point at which the pre-set apparatus is to operate based on at least one from among an operation state of the pre-set apparatus, the second control operation, or the third control operation, and control the communication interface 110 to transmit information about the time-point at which the pre-set apparatus is to operate to the pre-set apparatus.

In the above-described example, the processor 120 may identify a time-point at which the oven is to be pre-heated and a time-point at which the oven is to be heated based on at least one from among the operation state of the oven, the heat operation, or the pre-heat operation, and control the communication interface 110 to transmit information about the time-point at which the oven is to be pre-heated and the time-point at which the oven is to be heated to the oven. The oven may perform the pre-heat operation and heat operation based on the received information.

The processor 120 may control, as an apparatus that corresponds to the time-point at which the pre-set apparatus is to operate among the apparatuses of at least a portion, the communication interface 110 to transmit a signal controlling to guide an operation of the pre-set apparatus.

In the above-described example, the processor 120 may identify, based on the pre-heat operation of the oven being identified as necessary for 10 minutes, the apparatus to be used 10 minutes prior to the heat operation of the oven being started. In an example, the processor 120 may identify the induction heating surface as the apparatus to be used 10 minutes prior to the heat operation of the oven being started. In this case, the processor 120 may control the communication interface 110 to transmit a signal controlling to guide the pre-heat operation of the oven to the induction heating surface. The induction heating surface may provide to the user information that the oven is to be pre-heated at the time-point at which the oven is pre-heated.

As described above, time required to pre-heat may be saved by not performing the pre-heat operation, which requires a certain time, after using the hood and the induction heating surface, but rather performing the pre-heat operation a little more in advance.

A function associated with artificial intelligence according to the disclosure may be operated through the processor 120 and a memory.

The processor 120 may be formed of one or a plurality of processors. At this time, the one or plurality of processors may be a generic-purpose processor such as a central processing unit (CPU), an application processor (AP), or a digital signal processor (DSP), a graphics dedicated processor such as a graphic processing unit (GPU) or a vision processing unit (VPU), or an artificial intelligence dedicated processor such as an neural processing unit (NPU).

The one or plurality of processors may control for the input data to be processed according to a pre-defined operation rule or an artificial intelligence model stored in the memory. Alternatively, if the one or plurality of processors is an artificial intelligence dedicated processor, the artificial intelligence dedicated processor may be designed to a hardware structure specializing in the processing of a specific artificial intelligence model. The pre-defined operation rule or the artificial intelligence model may be characterized by being created through learning.

The being created through learning referred to herein refers to the pre-defined operation rule or artificial intelligence model set to perform a desired feature (or, purpose) being created as a basic artificial intelligence model trained by a learning algorithm using a plurality of learning data. The learning may be carried out in a device itself in which the artificial intelligence according to the disclosure is performed, or the learning may be carried out through a separate server and/or system. Examples of the learning algorithm may include a supervised learning, an unsupervised learning, a semi-supervised learning, or a reinforcement learning, but is not limited to the above-described examples.

The artificial intelligence model may be formed of a plurality of neural network layers. Each of the neural network layers may include a plurality of weight values, and perform a neural network computation through computation between a computation result of a previous layer and the plurality of weight values. The plurality of weight values included in the plurality of neural network layers may be optimized by a learning result of the artificial intelligence model. For example, the plurality of weight values may be updated for a loss value or a cost value obtained by the artificial intelligence model during the learning process to be reduced or minimized.

The artificial neural network may include a Deep Neural Network (DNN), and examples thereof may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Generative Adversarial Network (GAN), a Deep-Q Networks, or the like, but is not limited thereto.

As described above, the server 100 may enhance user convenience by identifying the apparatus to be used after based on at least one use information from among the plurality of electronic apparatuses 200-1 to 200-N, and controlling the apparatus to be used after. In addition, the server 100 may enhance user convenience by controlling in advance a specific operation of the apparatus to be used after and completing a preparation state at a time-point at which the apparatus to be used after is to be used.

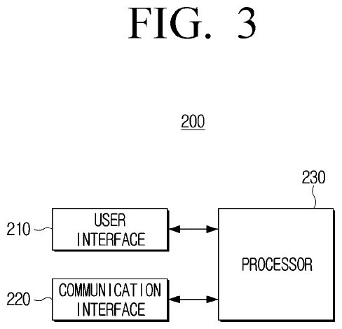

FIG. 3 is a block diagram illustrating a configuration of an electronic apparatus 200 according to one or more embodiments. In FIG. 2, the server 100 has been described as managing operations of the plurality of electronic apparatuses 200-1 to 200-N, but is not limited thereto. For example, one from among the plurality of electronic apparatuses 200-1 to 200-N may manage the remaining electronic apparatuses, and in FIG. 3, one from among the plurality of electronic apparatuses 200-1 to 200-N will be described as an electronic apparatus 200, and the remaining electronic apparatuses as a plurality of other electronic apparatuses.

Referring to FIG. 3, the electronic apparatus 200 may include a user interface 210, a communication interface 220, and at least one processor 230.

The user interface 210 may be realized with a button, a touch pad, a mouse and a keyboard, or realized as a touch screen capable of performing a display function and an operation input function together therewith. Here, the button may be a button of various types such as a mechanical button, a touch pad, or a wheel which is formed at a random area at a front surface part or a side surface part, a rear surface part, or the like of an exterior of a main body of the electronic apparatus 200.

The communication interface 220 may be a configuration that performs communication with external apparatuses of various types according to communication methods of various types. For example, the electronic apparatus 200 may perform communication with the server 100 and each of the other electronic apparatuses through the communication interface 220.

The communication interface 220 may include a Wi-Fi module, a Bluetooth module, an infrared communication module, a wireless communication module, and the like. Here, each communication module may be realized in at least one hardware chip form.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and after communicatively connecting using the same, various information may be transmitted and received. The infrared communication module may perform communication according to an infrared communication (Infrared Data Association (IrDA)) technology of transmitting data wirelessly in short range by using infrared rays present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

Alternatively, the communication interface 220 may include a wired communication interface such as, for example, and without limitation, HDMI, DP, Thunderbolt, USB, RGB, D-SUB, DVI, and the like.

In addition thereto, the communication interface 220 may include at least one from among the wired communication modules that perform communication using the local area network (LAN) module, the Ethernet module, or the pair cable, the coaxial cable or the optical fiber cable, or the like.

The processor 230 may control the overall operation of the electronic apparatus 200. Specifically, the processor 230 may control the overall operation of the electronic apparatus 200 by being connected with each configuration of the electronic apparatus 200. For example, the processor 230 may be connected with configurations such as the user interface 210, the communication interface 220, a memory, and the like and control an operation of the electronic apparatus 200.

At least one processor 230 may include at least one from among the CPU, the GPU, the APU, the MIC, the NPU, the hardware accelerator, or the machine learning accelerator. The at least one processor 230 may control one or a random combination from among other elements of the electronic apparatus 200, and perform an operation associated with communication or data processing. The at least one processor 230 may execute at least one program or instruction stored in the memory. For example, the at least one processor 230 may perform, by executing at least one instruction stored in the memory, a method according to one or more embodiments of the disclosure.

If a method according to one or more embodiments of the disclosure includes a plurality of operations, the plurality of operations may be performed by one processor or by a plurality of processors. For example, when a first operation, a second operation, and a third operation are performed by a method according to one or more embodiments, the first operation, the second operation, and the third operation may all be performed by the first processor, or the first operation and the second operation may be performed by the first processor (e.g., the generic-purpose processor) and the third operation may be performed by the second processor (e.g., the artificial intelligence dedicated processor).

The at least one processor 230 may be realized as a single core processor that includes one core, or as at least one multicore processor that includes a plurality of cores (e.g., a homogeneous multicore or a heterogeneous multicore). If the at least one processor 230 is realized as the multicore processor, each of the plurality of cores included in the multicore processor may include a memory inside the processor such as the cache memory and the on-chip memory, and the common cache shared by the plurality of cores may be included in the multicore processor. In addition, each of the cores (or a portion from among the plurality of cores) included in the multicore processor may independently read and perform a program command for realizing a method according to one or more embodiments, or read and perform the program command for realizing a method according to one or more embodiments of the disclosure due to the whole (or portion) of the plurality of cores being interconnected.

When a method according to one or more embodiments of the disclosure includes a plurality of operations, the plurality of operations may be performed by one core from among the plurality of cores or by the plurality of cores included in the multicore processor. For example, when a first operation, a second operation, and a third operation are performed by a method according to one or more embodiments, the first operation, the second operation, and the third operation may all be performed by the first core included in the multicore processor, or the first operation and the second operation may be performed by the first core included in the multicore processor and the third operation may be performed by the second core included in the multicore processor.

According to one or more embodiments, the at least one processor 230 may refer to a system on chip (SoC), a single core processor, or a multicore processor in which the at least one processor and other electronic components are integrated or a core included in the single core processor or the multicore processor, and the core herein may be realized as the CPU, the GPU, the APU, the MIC, the NPU, the hardware accelerator, the machine learning accelerator, or the like, but is not limited to the one or more embodiments of the disclosure. However, for convenience of description, an operation of the electronic apparatus 200 will be described below using the expression “processor 230.”

The processor 230 may obtain, based on a user command controlling the electronic apparatus 200 being received through the user interface 210, information about one from among the plurality of other electronic apparatuses identified based on at least one from among the use information about at least one from among the plurality of other electronic apparatuses prior to the user command being received or the user command as the apparatus to be used after, and control the communication interface 220 to transmit a control signal for controlling one from among the plurality of other electronic apparatuses to the one from among the plurality of other electronic apparatuses.

For example, if the electronic apparatus 200 is the refrigerator, the processor 230 may obtain, based on the refrigerator compartment being opened and closed, information about the oven based on the opening and closing of the refrigerator compartment as the apparatus to be used after, and control the communication interface 220 to transmit a control signal for controlling the oven to the oven. Alternatively, the processor 230 may transmit the control signal for controlling the oven to the server 100, and the server 100 may transmit the control signal for controlling the oven to the oven.

Alternatively, if the electronic apparatus 200 is the refrigerator, the processor 230 may obtain, based on the refrigerator compartment being opened and closed, information about the oven based on a supplying of water in the water purifier prior to the opening and closing of the refrigerator compartment and the opening and closing of the refrigerator as the apparatus to be used after, and control the communication interface 220 to transmit the control signal for controlling the oven to the oven. That is, the processor 230 may obtain information about the apparatus to be used after taking into further consideration use information of the plurality of other electronic apparatuses prior to using the electronic apparatus 200.

The electronic apparatus 200 may further include a memory stored with a neural network model, and the processor 230 may control, based on a user command being received, the communication interface 220 to transmit a signal requesting use information of the plurality of other electronic apparatuses prior to the user command being received to the server 100, receive use information about at least one from among the plurality of other electronic apparatuses from the server 100 through the communication interface 220, and obtain information about one from among the plurality of other electronic apparatuses by inputting the use information about at least one and the user command to the neural network model as the apparatus to be used after. Here, the neural network model may be a model that learned the use pattern of the user for the electronic apparatus 200 and the plurality of other electronic apparatuses.

Alternatively, the processor 230 may control, based on a user command being received, the communication interface 220 to transmit the user command to the server 100, and receive, through the communication interface 220, information about one from among the plurality of other electronic apparatuses identified based on the use information about at least one from among the plurality of other electronic apparatuses and the user command from the server 100, and identify the information about one from among the plurality of other electronic apparatuses as the apparatus to be used after.

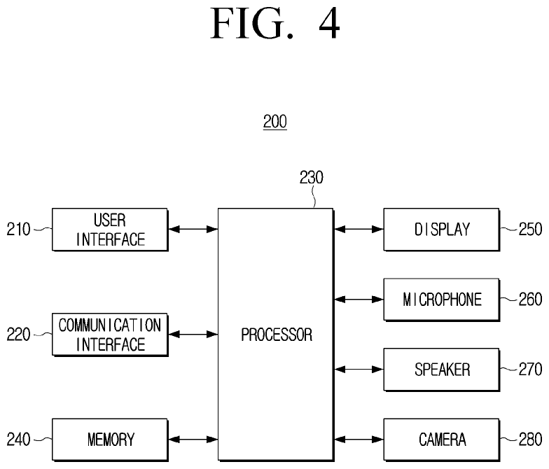

FIG. 4 is a block diagram illustrating a detailed configuration of the electronic apparatus 200 according to one or more embodiments.

FIG. 4 is a block diagram illustrating a detailed configuration of the electronic apparatus 200 according to one or more embodiments. The electronic apparatus 200 may include the user interface 210, the communication interface 220, and the at least one processor 230. In addition, referring to FIG. 4, the electronic apparatus 200 may further include a memory 240, a display 250, a microphone 260, a speaker 270, and a camera 280. Detailed descriptions of parts that overlap with elements shown in FIG. 3 from among the elements shown in FIG. 4 may be omitted.

The memory 240 may refer to a hardware that stores information such as data in electric or magnetic form for the processor 230 and the like to access. To this end, the memory 240 may be realized as at least one hardware from among a non-volatile memory, a volatile memory, a flash memory, a hard disk drive (HDD) or a solid state drive (SSD), a random access memory (RAM), a read only memory (ROM), and the like.

In the memory 240, at least one instruction necessary in an operation of the electronic apparatus 200 or the processor 230 may be stored. Here, the instruction may be a code unit that instructs an operation of the electronic apparatus 200 or the processor 230, and may be prepared in a machine language which is a language that can be understood by a computer. Alternatively, the memory 240 may be stored with a plurality of instructions that perform a specific work of the electronic apparatus 200 or the processor 230 as an instruction set.

The memory 240 may be stored with data which is information in a bit or byte unit that can represent a character, a number, an image, and the like. For example, the memory 240 may be stored with information about the neural network model, and the like.

The memory 240 may be accessed by the processor 230 and reading, writing, modifying, deleting, updating, and the like of the instruction, the instruction set, or data may be performed by the processor 230.

The display 250 may be a configuration that displays an image, and may be realized as a display of various forms such as a liquid crystal display (LCD), an organic light emitting diode (OLED) display, and a plasma display panel (PDP). In the display 250, a driving circuit, which may be realized in the form of an a-si TFT, a low temperature poly silicon (LTPS) TFT, an organic TFT (OTFT), or the like, a backlight unit, and the like may be included. The display 250 may be realized as a touch screen coupled with a touch sensor, a flexible display, a three-dimensional display (3D display), or the like.

The processor 230 may control the display 250 to display an operation state of at least one from among the electronic apparatus 200 or the plurality of other electronic apparatuses.

The microphone 260 may be a configuration for receiving sound and converting to an audio signal. The microphone 260 may be electrically connected with the processor 230, and may receive sound by the control of the processor 230.

For example, the microphone 260 may be formed as an integrated-type integrated to an upper side or a front surface direction, a side surface direction or the like of the electronic apparatus 200. Alternatively, the microphone 260 may be provided in a remote controller, or the like separate from the electronic apparatus 200. In this case, the remote controller may receive sound through the microphone 260, and provide the received sound to the electronic apparatus 200.

The microphone 260 may include various configurations such as a microphone that collects sound of an analog form, an amplifier circuit that amplifies the collected sound, an A/D converter circuit that samples the amplified sound and converts to a digital signal, a filter circuit that removes noise components from the converted digital signal, and the like.

The microphone 260 may be realized in a form of a sound sensor, and may be any method so long as it is a configuration that can collect sound.

The processor 230 may also receive the user command through the microphone 260.

The speaker 270 may be an element that outputs not only various audio data processed in the processor 230, but also various notification sounds, voice messages, or the like.

The processor 230 may control the speaker 270 to output sound guiding the operation state of the electronic apparatus 200 or at least one from among the plurality of other electronic apparatuses.

In addition to the above, the electronic apparatus 200 may further include the camera 280. The camera 280 may be a configuration for capturing a still image or a moving image. The camera 280 may capture the still image at a specific time point, but may also capture the still image consecutively.

The camera 280 may include a lens, a shutter, an aperture, a solid-state imaging apparatus, an Analog Front End (AFE), and a Timing Generator (TG). The shutter may be configured to adjust a time during which light reflected from a subject enters the camera 280, and the aperture may be configured to adjust an amount of light incident to the lens by mechanically increasing or decreasing a size of an opening part through which light enters. The solid-state imaging apparatus may be configured to output, based on light reflected from the subject being accumulated as photo charge, an image by the photo charge as an electric signal. The TG may be configured to output a timing signal for reading out pixel data of the solid-state imaging apparatus, and the AFE may be configured to digitalize the electric signal output from the solid-state imaging apparatus by sampling.

The processor 230 may receive a user command based on an interaction of the user captured through the camera 280.

As described above, the electronic apparatus 200 may obtain information about the apparatus to be used after based on use information of at least one from among the plurality of other electronic apparatuses, and enhance user convenience by controlling the apparatus to be used after. In addition, the electronic apparatus 200 may enhance user convenience based on completing the preparation state at the time-point at which the apparatus to be used after is used by controlling in advance a specific operation of the apparatus to be used after.

In FIG. 3 and FIG. 4, an operation of the electronic apparatus 200 identifying the apparatus to be used after by communicating with the server 100 has been described, but is not limited thereto. For example, the electronic apparatus 200 may perform an operation of the server 100 without the server 100. In this case, the electronic apparatus 200 may perform an operation of an IoT server that manages the plurality of other electronic apparatuses. For example, the plurality of other electronic apparatuses may transmit, based on the operation state being changed, the changed operation state to the electronic apparatus 200, the electronic apparatus 200 may identify the apparatus to be used after based on at least one use information from among the plurality of other electronic apparatuses, and transmit a control signal for the apparatus to be used after to the apparatus to be used after. In addition, even in this case, the electronic apparatus 200 may be in a state connected to the internet, and the user may control the electronic apparatus 200 through a user terminal apparatus from the outside or control the plurality of other electronic apparatuses through the electronic apparatus 200.

For convenience of description, the server 100 has been described as managing the plurality of electronic apparatuses 200-1 to 200-N below.

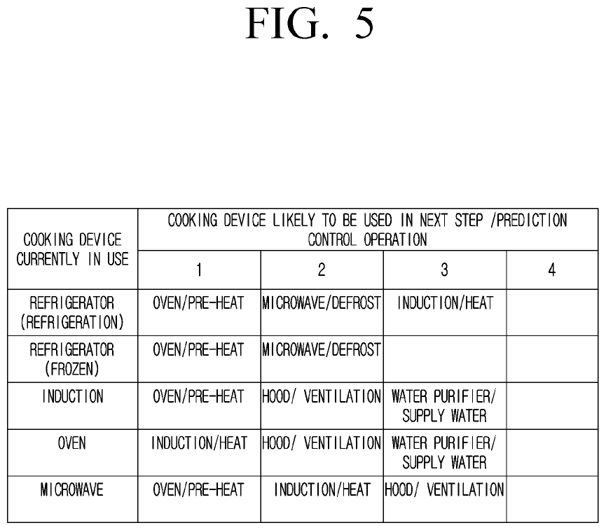

In addition, an operation of the server 100 will be described in greater detail below through FIG. 5 to FIG. 15. In FIG. 5 to FIG. 15, separate embodiments will be described for convenience of description. However, the separate embodiments of FIG. 5 to FIG. 15 may be realized in any combined state.

FIG. 5 is a diagram illustrating an operation of identifying an apparatus to be used after according to one or more embodiments.

First, the processor 120 may learn use patterns of the plurality of electronic apparatuses 200-1 to 200-N of the user. For example, the processor 120 may store, based on the user pre-heating the oven after using the refrigerator compartment of the refrigerator, the information in the memory. The processor 120 may store, based on the user heating the induction heating surface after using the refrigerator compartment of the refrigerator, the information in the memory. The processor 120 may accumulate and store the information, and obtain a database as shown in FIG. 5. Referring to FIG. 5, when the user used the refrigerator compartment of the refrigerator, cases of pre-heating the oven was shown most, then defrosting the microwave, and then followed by heating the induction heating surface.

The processor 120 may identify, based on use information about at least one from among the plurality of electronic apparatuses 200-1 to 200-N being received, one from among the plurality of electronic apparatuses 200-1 to 200-N as the apparatus to be used after based on the use information, and transmit the first control signal for controlling one from among the plurality of electronic apparatuses 200-1 to 200-N to one from among the plurality of electronic apparatuses 200-1 to 200-N. For example, the processor 120 may identify, based on information that the user is using the refrigerator compartment of the refrigerator being received from the refrigerator, the oven as the apparatus to be used after as shown in FIG. 5, and transmit the first control signal for pre-heating the oven to the oven.

However, the above is not limited thereto, and the processor 120 may identify, based on use information about at least one from among the plurality of electronic apparatuses 200-1 to 200-N being received, a portion from among the plurality of electronic apparatuses 200-1 to 200-N as the apparatus to be used after based on the use information, and transmit a signal for guiding the portion from among the plurality of electronic apparatuses 200-1 to 200-N to the apparatus that transmitted the use information.

For example, the processor 120 may identify, based on information that the user is using the refrigerator compartment of the refrigerator being received from the refrigerator, the oven, the microwave, and the induction heating surface as apparatuses to be used after as shown in FIG. 5, and transmit a signal controlling for a screen through which one from among the oven, the microwave, and the induction heating surface is selectable to be displayed to the refrigerator. The refrigerator may display a screen through which one from among the oven, the microwave, and the induction heating surface is selectable, and transmit, based on a command selecting one therefrom being received from the user, information about the selected apparatus to the server 100. The processor 120 may transmit the first control signal for controlling the selected apparatus to the selected apparatus.

In FIG. 5, a database based on rules being obtained has been described for convenience of description, but is not limited thereto. For example, the use patterns of the plurality of electronic apparatuses 200-1 to 200-N of the user may be learned through a neural network, and the processor 120 may identify the apparatus to be used after by inputting use information about at least one from among the plurality of electronic apparatuses to the neural network model.

In addition, in FIG. 5, only the use information of the refrigerator has been described as being used, but the disclosure is not limited thereto. For example, the database may include information about the apparatus to be used after according to use information of at least two electronic apparatuses. In an example, the database may include information that the oven is the apparatus to be used after according to use information of the refrigerator compartment of the refrigerator being used, and an operation of ventilating the hood being performed. Here, the use information of the at least two electronic apparatuses may include information that a difference between each of the time-points for start of use is within a pre-set time.

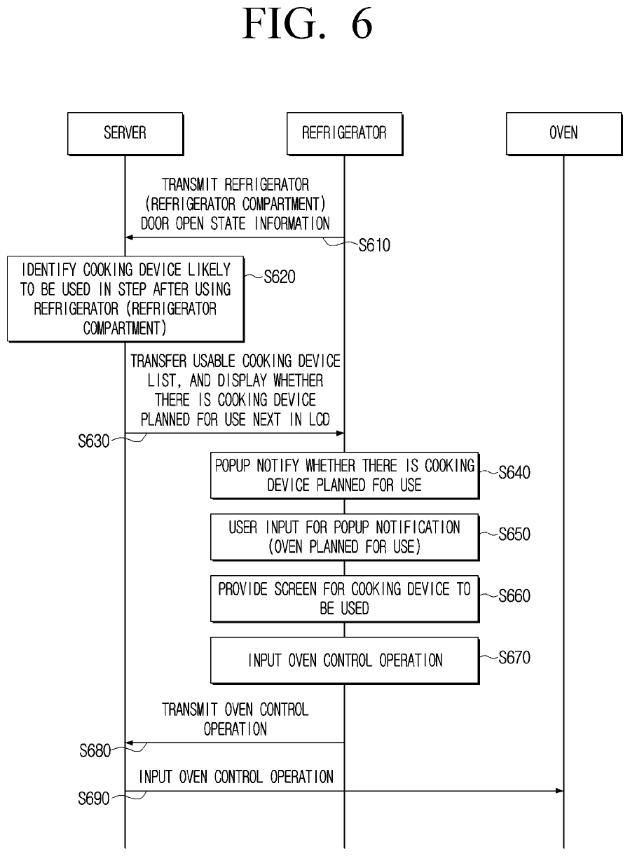

FIG. 6 is a sequence diagram illustrating an operation of controlling an apparatus to be used after according to one or more embodiments. In FIG. 6, for convenience of description, an operation in which ultimately the oven is controlled according to the use of the refrigerator will be described. However, the disclosure is not limited thereto, and any combination between the apparatuses may be possible according to the use pattern of the user.

First, the refrigerator may transmit, based on the refrigerator compartment being opened, a door open state information of the refrigerator compartment to the server 100 (S610).

The server 100 may identify a usable cooking device after use of the refrigerator as the apparatus to be used after (S620), and transmit the identified apparatus to the refrigerator (S630). For example, the server 100 may identify the oven, the microwave, and the induction heating surface as the apparatus to be used after, and transmit a signal controlling a screen that guides for one from among the oven, the microwave, and the induction heating surface to be selected to be displayed to the refrigerator.

The refrigerator may display the screen guiding for one from among the oven, the microwave, and the induction heating surface to be selected as a popup notification (S640), and receive a user command selecting the oven for the popup notification (S650). The refrigerator may display a screen showing the oven (S660), receive a user command controlling the oven from the user (S670), and transmit an oven control operation to the server 100 (S680).

The server 100 may transmit the oven control operation to the oven (S690). However, the above is not limited thereto, and the refrigerator may transmit the oven control operation to the oven.

In FIG. 6, the refrigerator has been described as receiving the oven control operation from the user, but the disclosure is not limited thereto. For example, the server 100 may identify the oven, the microwave, and the induction heating surface as the usable cooking devices after the use of the refrigerator, and identify the pre-heat operation of the oven, the defrost operation of the microwave, and the heat operation of the induction heating surface as the operation of the apparatus to be used after. The server 100 may transmit a signal controlling for a screen that guides one from among the pre-heat operation of the oven, the defrost operation of the microwave, and the heat operation of the induction heating surface to be selected to be displayed to the refrigerator, the refrigerator may display a screen guiding for one from among the pre-heat operation of the oven, the defrost operation of the microwave, and the heat operation of the induction heating surface to be selected as the popup notification, and receive a user command of selecting the pre-heat operation of the oven for the popup notification. The refrigerator may display a screen showing the pre-heat operation of the oven, and transmit that that the pre-heat operation of the oven has been selected to the server 100. The server 100 may transmit a pre-heat command to the oven.

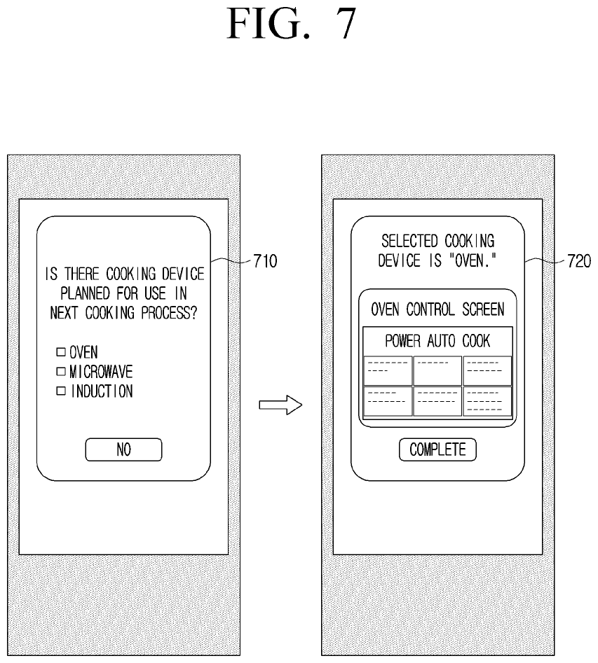

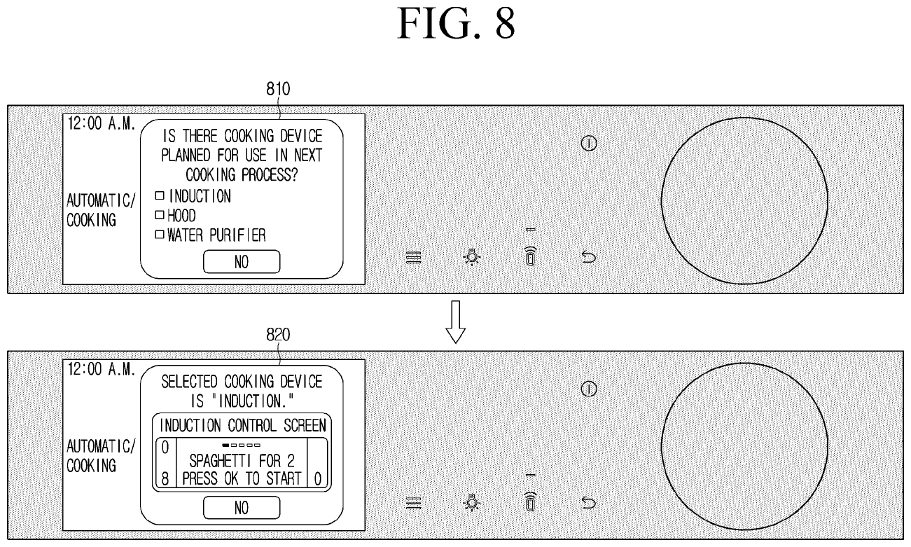

FIG. 7 and FIG. 8 are diagrams illustrating a screen guiding an apparatus to be used after according to one or more embodiments.

The electronic apparatus that transmitted the use information to the server 100 may receive information about the apparatus to be used after from the server 100. For example, the refrigerator may transmit use information to the server 100, receive information about the oven, the microwave, and the induction heating surface from the server 100, and as shown at the left side of FIG. 7, display a screen 710 guiding for one from among the oven, the microwave, and the induction heating surface to be selected.

The refrigerator may display, based on a user command of selecting the oven being received from the user, an oven control screen 720 as shown at the right side of FIG. 7.

However, the disclosure is not limited thereto, and the refrigerator may receive not only information about the apparatus to be used after, but also information about operations of each of the apparatuses to be used after from the server 100. In this case, the refrigerator may additionally display operation information of each of the apparatuses in a screen as shown at the left side of FIG. 7. Alternatively, the refrigerator may display a screen as in the left side of FIG. 7, and if the oven is selected, display a screen recommending an operation of the oven received from the server in place of the screen at the right side of FIG. 7.

The refrigerator may transmit, based on the oven control operation being selected, the same to the server 100, and the server 100 may transmit the signal for controlling the oven to the oven.

Then, the server 100 may identify the apparatus to be used after based on the use information of the oven. For example, the server 100 may identify the induction heating surface, the hood, and the water purifier as apparatuses to be used after based on the use information of the oven.

However, the disclosure is not limited thereto, and the server 100 may identify, based on the oven being identified as having been used within a pre-set time from the time-point at which the refrigerator is used, the apparatus to be used after based on the use information of the refrigerator and the use information of the oven.

The server 100 may transmit a signal controlling for a screen that guides one from among the induction heating surface, the hood, and the water purifier to be selected to be displayed to the oven. The oven may display a screen 810 guiding for one from among the induction heating surface, the hood, and the water purifier to be selected as shown in FIG. 8, and when the user command selecting the induction heating surface is received from the user, display an induction heating surface control screen 820.

The oven may transmit, based on an induction heating surface control operation being selected, the same to the server 100, and the server 100 may transmit a signal for controlling the induction heating surface to the induction heating surface.

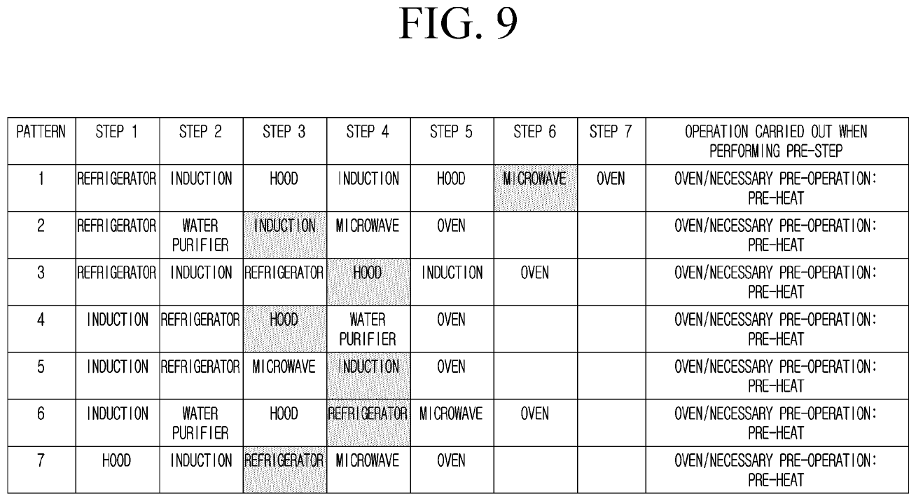

FIG. 9 is a diagram illustrating an operation of when a pre-set apparatus is included among apparatuses to be used after according to one or more embodiments.

First, the processor 120 may learn use patterns of the plurality of electronic apparatuses 200-1 to 200-N of the user. For example, the processor 120 may store, based on use information of the refrigerator, the induction heating surface, the hood, the induction heating surface, the hood, the microwave, and the oven being sequentially received as pattern 1 in FIG. 9, the information in the memory. The processor 120 may store, based on use information of the refrigerator, the water purifier, the induction heating surface, the microwave, and the oven being sequentially received as pattern 2 in FIG. 9, the information in the memory. The processor 120 may accumulate and store the information, and obtain a database as in FIG. 9.

The processor 120 may identify at least a portion from among the plurality of electronic apparatuses 200-1 to 200-N as apparatuses to be used after based on the use information, and control the communication interface 110 to transmit, based on the pre-set apparatus being included among the apparatuses of at least a portion, the second control signal for controlling the pre-set apparatus to the pre-set apparatus.

For example, the processor 120 may identify, based on use information of the refrigerator, the induction heating surface, the hood, the induction heating surface and the hood being sequentially received as shown in pattern 1 of FIG. 9, the microwave and the oven as the apparatuses to be used after. The processor 120 may transmit, based on the oven being identified as the pre-set apparatus, the second control signal for controlling the oven to the oven. Here, the pre-set apparatus may be an apparatus that requires a prerequisite operation for performing a specific operation. For example, because the oven requires the pre-heat operation as the prerequisite operation for performing the heat operation, the oven may be the pre-set apparatus.

The processor 120 may identify the second control operation of the pre-set apparatus based on the use information, identify the third control operation of the pre-set apparatus necessary for performing the second control operation, and control the communication interface 110 to transmit the second control signal to the pre-set apparatus based on at least one from among the second control operation or the third control operation. The processor 120 may identify a time-point at which the pre-set apparatus is to operate based on at least one from among the operation state of the pre-set apparatus, the second control operation, or the third control operation, and control the communication interface 110 to transmit information about the time-point at which the pre-set apparatus is to operate to the pre-set apparatus.

For example, the processor 120 may identify the heat operation of the oven based on the use information, identify the pre-heat operation of the oven necessary for performing the heat operation, and transmit the second control signal to the pre-set apparatus based on at least one from among the heat operation or the pre-heat operation. The processor 120 may identify the time-point at which the oven is to operate based on at least one from among the operation state of the oven, the heat operation, or the pre-heat operation, and transmit information about the time-point at which the oven is to operate to the oven. In an example, the processor 120 may transmit a control signal to start the heat operation of the oven after 20 minutes, identify a 10 minute pre-heat operation being necessary based on a current temperature and heat temperature of the oven, and perform the pre-heat operation 10 minutes after and perform the heat operation 20 minutes after.

The processor 120 may control, as an apparatus that corresponds to the time-point at which the pre-set apparatus is to operate among the apparatuses of at least a portion, the communication interface 110 to transmit a signal that controls to guide an operation of the pre-set apparatus. In the above-described example, the processor 120 may transmit a signal guiding that the pre-heat operation of the oven has been performed to the microwave that is to operate 10 minutes after, which is the time-point at which the oven performs the pre-heat operation. In FIG. 9, the oven in each pattern is the pre-set apparatus, and the shaded parts show apparatuses guiding the pre-heat operation of the oven.

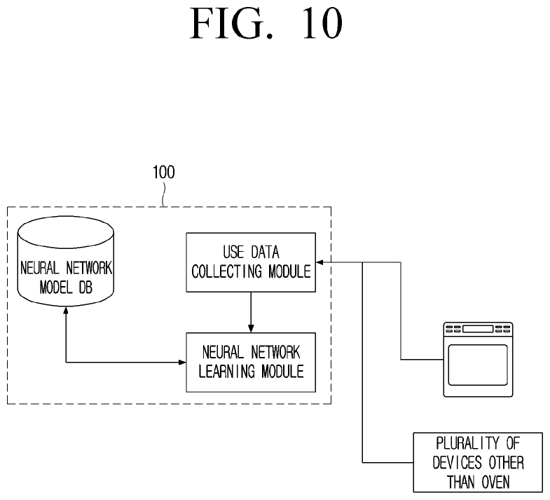

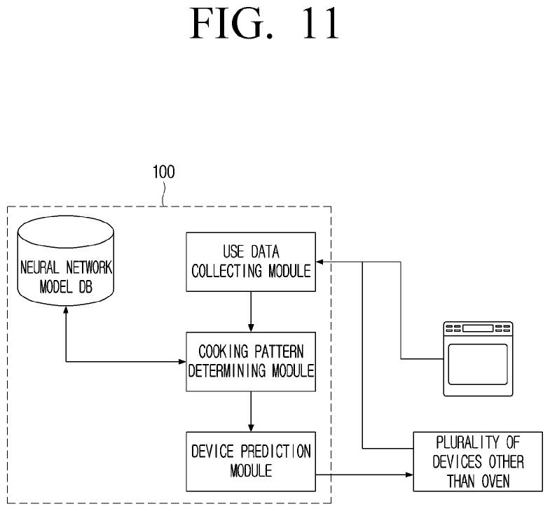

FIG. 10 and FIG. 11 are diagrams illustrating a method of using a neural network model according to one or more embodiments.

In FIG. 9, a database based on rules being realized has been described for convenience of description, but is not limited thereto, and a neural network model may be realized based on the database.

The processor 120 may collect, by executing a use data collecting module as shown in FIG. 10, use information from the plurality of electronic apparatuses 200-1 to 200-N. The processor 120 may train the neural network model based on the use information by executing a neural network learning module, and obtaining a neural network model database.

For example, the processor 120 may train the neural network model based on patterns as in FIG. 9. In an example, the processor 120 may train the neural network model using the refrigerator, the induction heating surface, the hood, the induction heating surface, the hood, and the microwave from pattern 1 in FIG. 9 as input data, and the oven as output data. Alternatively, the processor 120 may train the neural network model using the refrigerator, the induction heating surface, the hood, the induction heating surface, and the hood from pattern 1 in FIG. 9 as the input data, and the microwave and the oven as the output data.

The processor 120 may identify, by executing a cooking pattern determining module when the use information is received as shown in FIG. 11, a cooking pattern corresponding to the use information based on the neural network model, identify the apparatus to be used after by executing a device prediction module, and transmit the control signal for controlling the apparatus to be used after to the apparatus to be used after.

For example, the processor 120 may identify, based on use information of using the oven being received, a cooking pattern by inputting the use information of the oven, the use information of other apparatuses prior to use of the oven, and the like in the neural network model, and identify the apparatus to be used after according to the cooking pattern. The processor 120 may enhance user convenience by transmitting a control signal to the apparatus to be used after.

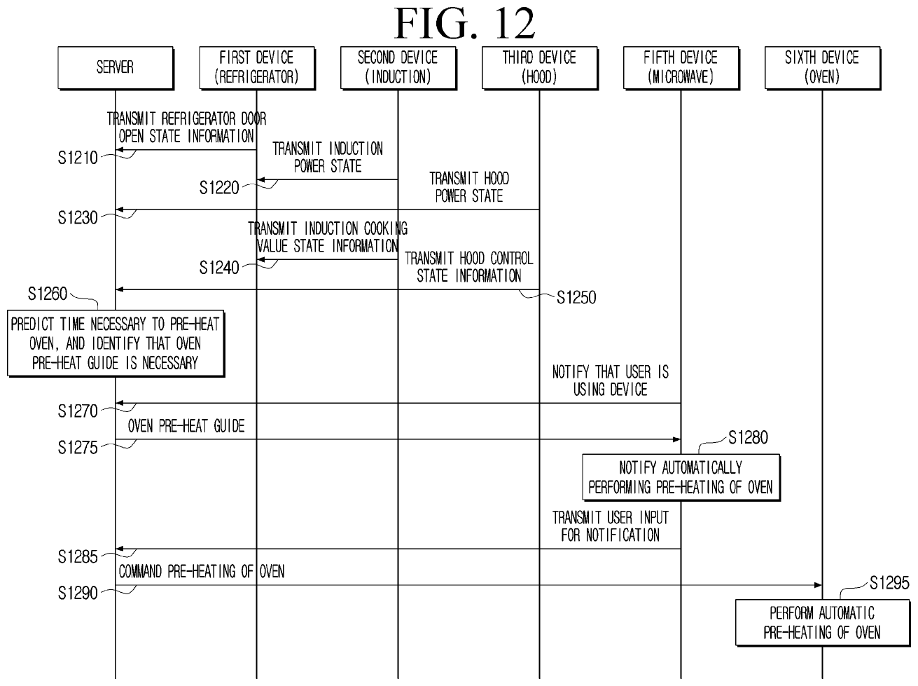

FIG. 12 is a sequence diagram illustrating an operation of when a pre-set apparatus is included among apparatuses to be used after according to one or more embodiments.

First, the refrigerator may transmit refrigerator door open state information to the server 100 according to the opening of a refrigerator door (S1210). Then, the induction heating surface may transmit, as it is turned-on, a power state of the induction heating surface to the server 100 (S1220). Then, the hood may transmit, as it is turned-on, the power state of the hood to the server 100 (S1230). Then, the induction heating surface may transmit induction heating surface cooking value state information to the server 100 according to a heat command (S1240). Then, the hood may transmit hood control state information to the server 100 according to a ventilation operation (S1250).

The server 100 may identify the oven as the apparatus to be used after based on the received use information, and identify that an oven pre-heat guide is necessary by predicting the time necessary to pre-heat the oven (S1260).

The microwave may transmit, based on the microwave being turned-on, that the user is using the device to the server 100 (S1270).

The server 100 may transmit, based on the apparatus currently in use being identified as the microwave, the oven pre-heat guide to the microwave (S1275).

The microwave may automatically provide a notification of performing pre-heating of the oven (S1280). For example, the microwave may display a screen that guides the pre-heating of the oven through a display or output a message that guides the pre-heating of the oven with sound. The microwave may receive a user command for the notification, and transmit the user command to the server 100 (S1285).

The server 100 may transmit a command for pre-heating the oven to the oven if the user command is a simple verification command (S1290), and the oven may perform automatic pre-heating (S1295). However, the server 100 may not perform any operation if the user command is a cancellation command.

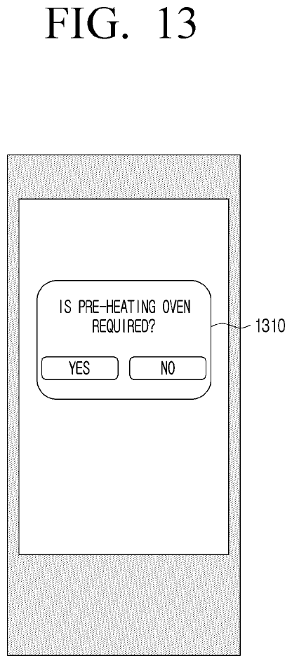

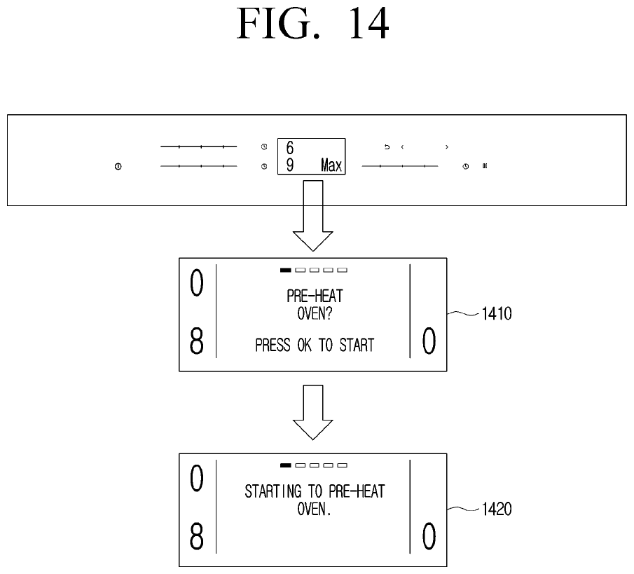

FIG. 13 and FIG. 14 are diagrams illustrating a method of guiding a preparation operation of a pre-set apparatus according to one or more embodiments.

The server 100 may identify the second control operation of the pre-set apparatus based on the use information, identify the third control operation of the pre-set apparatus necessary for performing the second control operation, and transmit a signal controlling to display a guide screen to the apparatus to be used at the time-point at which the pre-set device is to perform the third control operation.

For example, the server 100 may identify the heat operation of the oven and the pre-heat operation of the oven necessary for the heat operation, and transmit a signal controlling for the oven to display a guide screen to the refrigerator which is the apparatus to be used at the time-point at which the pre-heat operation is to be performed. The refrigerator may display a guide screen 1310 inquiring whether the pre-heating of the oven is required as shown in FIG. 13.

Alternatively, the server 100 may identify the heat operation of the oven and the pre-heat operation of the oven necessary for the heat operation, and transmit a signal controlling for the oven to display a guide screen to the induction heating surface which is the apparatus to be used at the time-point at which the pre-heat operation is to be performed. The induction heating surface may display a guide screen 1410 inquiring whether the pre-heating of the oven is required as shown in FIG. 14, and display a guide screen 1420 of starting to pre-heat the oven when an approving user command is received. However, the disclosure is not limited thereto, and the induction heating surface may output a beep sound while displaying the guide screen 410 inquiring whether the pre-heating of the oven is required. In addition, if there is a prior consent for the pre-heating of the oven, the induction heating surface may not display the guide screen 410 inquiring whether the pre-heating of the oven is required, and display the guide screen 1420 of starting to pre-heat the oven.

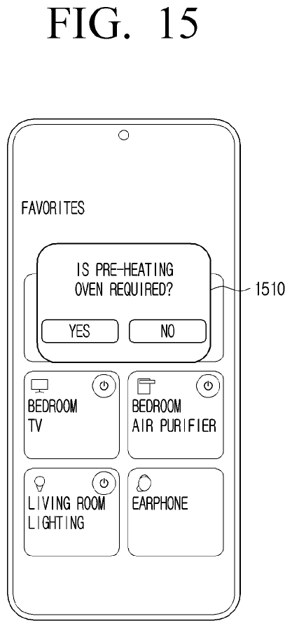

FIG. 15 is a diagram illustrating a guide of a user terminal apparatus according to one or more embodiments.

In the above, providing a guide through the plurality of electronic apparatuses 200-1 to 200-N has been described, but is not limited thereto. For example, the server 100 may transmit, if a guide is required, a signal controlling to display a guide screen inquiring whether the pre-heating of the oven is required to not only the apparatus that provided the use information, but also the user terminal apparatus. The user terminal apparatus may display a guide screen 1510 inquiring whether the pre-heating of the oven is required as shown in FIG. 15. Here, the user terminal apparatus may be a smartphone, a wearable apparatus, a tablet personal computer (PC), a notebook, a desktop, and the like, and may be any apparatus so long as it is an apparatus capable of providing notifications to the user.

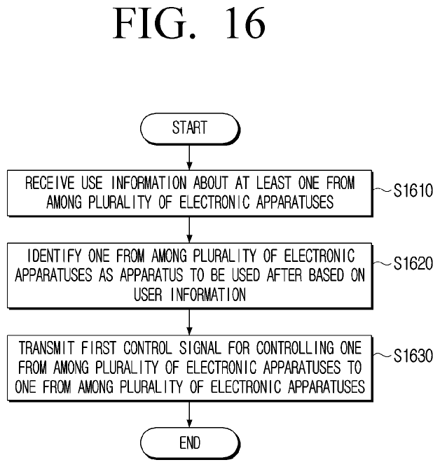

FIG. 16 is a flowchart illustrating a control method of a server according to one or more embodiments.

First, use information about at least one from among the plurality of electronic apparatuses may be received (S1610). Then, one from among the plurality of electronic apparatuses may be identified as the apparatus to be used after based on the use information (S1620). Then, the first control signal for controlling one from among the plurality of electronic apparatuses may be transmitted to the one from among the plurality of electronic apparatuses (S1630).

In addition, the identifying (S1620) may include identifying one from among the plurality of electronic apparatuses by inputting the use information to the neural network model, and the neural network model may be a model that learned the use pattern of the user for the plurality of electronic apparatus.

Then, the transmitting (S1630) may include identifying one from among the plurality of electronic apparatuses based on the use information and the first control operation of one from among the plurality of electronic apparatuses, and transmitting the first control signal to the one from among the plurality of electronic apparatuses based on the first control operation.

In addition, the transmitting (S1630) may include transmitting, based on the first control operation being a control operation of one from among the plurality of electronic apparatuses 200-1 to 200-N, the first control signal to the one from among the plurality of electronic apparatuses based on the first control operation, and transmitting, based on the first control operation being a control operation of a plurality of electronic apparatuses from among the plurality of electronic apparatuses 200-1 to 200-N, the signal controlling for a screen that guides the plurality of first control operations to be displayed to the one from among the plurality of electronic apparatuses.

Then, the identifying (S1620) may include identifying at least a portion from among the plurality of electronic apparatuses as the apparatuses to be used after based on the use information, and the control method may further include transmitting, based on the pre-set apparatus being included among the apparatuses of at least a portion, the second control signal for controlling the pre-set apparatus to the pre-set apparatus.

In addition, the transmitting the second control signal to the pre-set apparatus may include identifying the second control operation of the pre-set apparatus based on the use information, identifying the third control operation of the pre-set apparatus necessary for performing the second control operation, and transmitting the second control signal to the pre-set apparatus based on at least one from among the second control operation or the third control operation.

Then, the identifying the time-point at which the pre-set apparatus is to operate based on at least one from among the operation state of the pre-set apparatus, the second control operation, or the third control operation and the transmitting information about the time-point at which the pre-set apparatus is to operate to the pre-set apparatus may be further included.

In addition, the transmitting a signal controlling to guide an operation of the pre-set apparatus to the apparatus corresponding to the time-point at which the pre-set apparatus among the apparatuses of at least a portion is to operate may be further included.

Then, the server may be an internet of things (IoT) server that manages the operations of the plurality of electronic apparatuses.

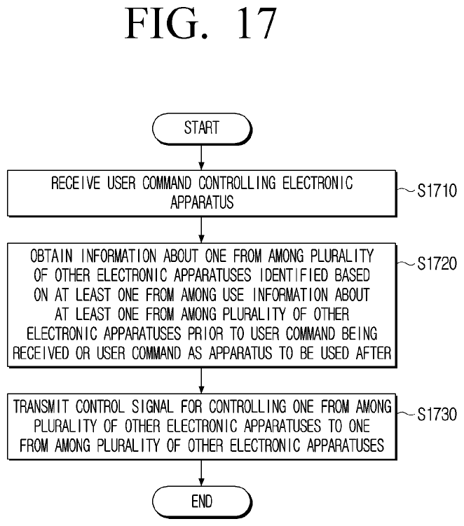

FIG. 17 is a flowchart illustrating a control method of an electronic apparatus according to one or more embodiments.

First, the user command that controls the electronic apparatus may be received (S1710). Then, information about one from among the plurality of other electronic apparatuses identified based on at least one from among the use information about at least one from among the plurality of other electronic apparatuses prior to the user command being received or the user command may be obtained as the apparatus to be used after (S1720). Then, the control signal for controlling one from among the plurality of other electronic apparatuses may be transmitted to one from among the plurality of other electronic apparatuses (S1730).

In addition, the obtaining (S1720) may include transmitting, based on a user command being received, a signal requesting the use information of the plurality of other electronic apparatuses prior to the user command being received to the server, receiving the use information about at least one from among the plurality of other electronic apparatuses from the server, and obtaining information about one from among the plurality of other electronic apparatuses by inputting the use information about the at least one and the user command to the neural network model as the apparatus to be used after, and the neural network model may be a model configured to learn the use patterns of the user for the electronic apparatus and the plurality of other electronic apparatuses.

Then, the obtaining (S1720) may include transmitting, based on the user command being received, the user command to the server, receiving information about one from among the plurality of other electronic apparatuses identified based on the use information about at least one from among the plurality of other electronic apparatuses and the user command from the server, and identifying information about one from among the plurality of other electronic apparatuses as the apparatus to be used after.

According to the various embodiments of the disclosure as described above, the server may identify the apparatus to be used after based on the use information of at least one from among the plurality of electronic apparatuses, and enhance user convenience by controlling the apparatus to be used after.

In addition, the server may enhance user convenience by controlling in advance the specific operation of the apparatus to be used after and completing the preparation state at the time-point at which the apparatus to be used after is to be used.

In the above, identifying the apparatus to be used after by using the use information of at least one from among the plurality of electronic apparatuses has been described, but is not limited thereto. For example, the refrigerator may transmit information about a product taken out from the refrigerator to the server, and the server may transmit, based on the taken out product being identified as a product necessary to pre-heating the oven, a control signal for pre-heating the oven to the oven. Here, the refrigerator may transmit an image of the taken out product to the server through a camera, or transmit a product name of the product taken out from the image of the taken out product to the server. The server may identify, based on the image of the taken out product being received, the product name of the product taken out from the image of the taken out product. In an example, the product name of the product may be identified from the image of the taken out product using the neural network model. Alternatively, the user may input information about the taken out product through an IoT application of the user terminal apparatus.

According to one or more embodiments of the disclosure, the various embodiments described above may be realized with software including instructions stored in a machine-readable storage media (e.g., computer). The machine may call an instruction stored in the storage medium, and as a device operable according to the called instruction, may include an electronic apparatus (e.g., electronic apparatus (A)) according to the above-mentioned embodiments. Based on an instruction being executed by the processor, the processor may directly or using other elements under the control of the processor perform a function corresponding to the instruction. The instruction may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

According to one or more embodiments, a method according to the various embodiments described above may be provided included a computer program product. The computer program product may be exchanged between a seller and a purchaser as a commodity. The computer program product may be distributed in the form of a machine-readable storage medium (e.g., a compact disc read only memory (CD-ROM)), or distributed online through an application store (e.g., PLAYSTORE™). In the case of online distribution, at least a portion of the computer program product (e.g., downloadable app) may be stored at least temporarily in the storage medium such as a server of a manufacturer, a server of an application store, or a memory of a relay server, or temporarily generated.

According to one or more embodiments of the disclosure, the various embodiments described above may be realized in a recordable medium which is readable by a computer or a device similar to the computer using software, hardware, or the combination of software and hardware. In some cases, embodiments described herein may be realized by the processor itself. According to a software implementation, embodiments such as the procedures and functions described herein may be realized with a separate software. The respective software may perform one or more functions and operations described herein.

The computer instructions for performing processing operations in a device according to the various embodiments described above may be stored in a non-transitory computer-readable medium. The computer instructions stored in this non-transitory computer-readable medium may cause a specific device to perform a processing operation from a device according to the above-described various embodiments when executed by a processor of the specific device. The non-transitory computer readable medium may refer to a medium that stores data semi-permanently rather than storing data for a very short time, such as a register, a cache, a memory, or the like, and is readable by a device. Specific examples of the non-transitory computer readable medium may include, for example, and without limitation, a compact disc (CD), a digital versatile disc (DVD), a hard disc, a Blu-ray disc, a USB, a memory card, a ROM, and the like.

In addition, respective elements (e.g., a module or a program) according to various embodiments described above may be formed of a single entity or a plurality of entities, and some sub-elements of the above-mentioned sub-elements may be omitted or other sub-elements may be further included in the various embodiments. Alternatively or additionally, some elements (e.g., modules or programs) may be integrated into one entity to perform the same or similar functions performed by the respective corresponding elements prior to integration. Operations performed by a module, a program, or other element, in accordance with the various embodiments, may be executed sequentially, in parallel, repetitively, or in a heuristically manner, or at least some operations may be performed in a different order, omitted, or a different operation may be added.

While various example embodiments have been illustrated and described, it will be understood that the various example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A server comprising:
a communication interface; and
at least one processor operatively connected to the communication interface and configured to:
identify, based on use information received through the communication interface and related to at least one from among a plurality of electronic apparatuses, a first electronic apparatus to be used after from among the plurality of electronic apparatuses, and
control the communication interface to transmit, to the first electronic apparatus from among the plurality of electronic apparatuses, a first control signal for controlling the first electronic apparatus.

2. The server of claim 1, further comprising:
a memory configured to store a neural network model,
wherein the at least one processor is operatively connected to the memory and is further configured to identify the first electronic apparatus by inputting the use information to the neural network model, and
wherein the neural network model is trained using patterns of use by a user of the plurality of electronic apparatuses.

3. The server of claim 1, wherein the at least one processor is further configured to:
identify a first control operation of the first electronic apparatus based on the use information, and
control the communication interface to transmit the first control signal to the first electronic apparatus based on the first control operation.

4. The server of claim 1, wherein the at least one processor is further configured to:
identify a first control operation of the first electronic apparatus based on the use information,
based on the first control operation being a single first control operation, control the communication interface to transmit the first control signal to the first electronic apparatus based on the single first control operation, and
based on the first control operation being a plurality of first control operations, control the communication interface to transmit a signal to display a screen on a display of the first electronic apparatus, wherein the screen is configured to guide a user through the plurality of first control operations.

5. The server of claim 1, wherein the at least one processor is further configured to:
identify, based on the use information, at least two electronic apparatuses to be used after from among the plurality of electronic apparatuses, wherein the at least two electronic apparatuses include the first electronic apparatus, and
control, based on the at least two electronic apparatuses including a pre-set apparatus, the communication interface to transmit to the pre-set apparatus a second control signal.

6. The server of claim 5, wherein the at least one processor is further configured to:
identify, based on the use information, a second control operation of the pre-set apparatus,
identify a third control operation of the pre-set apparatus necessary for performing the second control operation, and
control the communication interface to transmit the second control signal to the pre-set apparatus based on at least one of the second control operation or the third control operation.

7. The server of claim 5, wherein the at least one processor is further configured to:
identify a time-point at which the pre-set apparatus is to operate based on at least one from among an operation state of the pre-set apparatus, a second control operation, or a third control operation, and
control the communication interface to transmit information about the time-point at which the pre-set apparatus is to operate to the pre-set apparatus.

8. The server of claim 7, wherein the at least one processor is further configured to control the communication interface to transmit a signal to guide an operation of the pre-set apparatus to an electronic apparatus corresponding to the time-point at which the pre-set apparatus is to operate among the at least two electronic apparatuses.

9. The server of claim 1, wherein the server comprises an Internet of Things server configured to manage operations of the plurality of electronic apparatuses.

10. A method of controlling a server, the method comprising:
receiving use information related to at least one from among a plurality of electronic apparatuses;
identifying, based on the use information, a first electronic apparatus to be used after from among the plurality of electronic apparatuses; and
transmitting, to the first electronic apparatus, a first control signal for controlling the first electronic apparatus.

11. The method of claim 10, wherein the identifying comprises identifying the first electronic apparatus by inputting the use information to a neural network model, and
wherein the neural network model is trained using patterns of use of a user of the plurality of electronic apparatuses.

12. The method of claim 10, further comprising:
identifying a first control operation of the first electronic apparatus based on the use information,
wherein the transmitting comprises transmitting the first control signal to the first electronic apparatus based on the first control operation.

13. The method of claim 10, further comprising:
identifying a first control operation of the first electronic apparatus based on the use information,
wherein the transmitting comprises:
transmitting, based on the first control operation being a single first control operation, the first control signal to the first electronic apparatus based on the first control operation; and
transmitting, based on the first control operation being a plurality of first control operations, a signal causing a screen to be displayed on a display of the first electronic apparatus, wherein the screen is configured to guide a user through the plurality of first control operations.

14. The method of claim 10, wherein the identifying comprises identifying, based on the use information, at least two electronic apparatuses to be used after from among the plurality of electronic apparatuses, wherein the at least two electronic apparatuses include the first electronic apparatus, and
wherein the method further comprises:
based on the at least two electronic apparatuses including a pre-set apparatus, transmitting, to the pre-set apparatus, a second control signal for controlling the pre-set apparatus.

15. The method of claim 14, wherein the transmitting the second control signal comprises:
identifying, based on the use information, a second control operation of the pre-set apparatus;
identifying a third control operation of the pre-set apparatus necessary for performing the second control operation; and
transmitting the second control signal to the pre-set apparatus based on at least one of the second control operation or the third control operation.

16. An electronic apparatus management system comprising:
a plurality of electronic apparatuses, wherein each of the plurality of electronic apparatuses comprise a communication interface and at least one processor operatively connected to the communication interface,
wherein the at least one processor of a first electronic apparatus of the plurality of electronic apparatuses is configured to transmit, through the communication interface of the first electronic apparatus, use information of the first electronic apparatus in response to an event,
wherein the at least one processor of a second electronic apparatus of the plurality of electronic apparatuses is configured to:
receive, through the communication interface of the second electronic apparatus, the use information of the first electronic apparatus,
identify, based on the use information, an electronic apparatus to be used after from among the plurality of electronic apparatuses, and
control the communication interface of the second electronic apparatus to transmit a first control signal to the identified electronic apparatus to be used after.

17. The electronic apparatus management system of claim 16, wherein the second electronic apparatus further comprises a memory storing a neural network model,
wherein the at least one processor of the second electronic apparatus is further configured to identify the electronic apparatus to be used after by inputting the use information to the neural network model, and
wherein the neural network model is trained using patterns of use by a user of the plurality of electronic apparatuses.

18. The electronic apparatus management system of claim 16, wherein the at least one processor of the second electronic apparatus is further configured to:
identify a first control operation of the electronic apparatus to be used after based on the use information, and
control the communication interface of the second electronic apparatus to transmit the first control signal to the electronic apparatus to be used after based on the first control operation.

19. The electronic apparatus management system of claim 16, wherein the at least one processor of the second electronic apparatus is further configured to:
identify a first control operation of the electronic apparatus to be used after based on the use information,
control, based on the first control operation being a single first control operation, the communication interface of the second electronic apparatus to transmit the first control signal to the electronic apparatus to be used after based on the single first control operation, and
control, based on the first control operation being a plurality of first control operations, the communication interface of the second electronic apparatus to transmit a signal causing a screen to be displayed on a display of the electronic apparatus to be used after, wherein the screen is configured to guide a user through the plurality of first control operations.

20. The electronic apparatus management system of claim 16, wherein the at least one processor of the second electronic apparatus is further configured to:
identify, based on the use information, at least two electronic apparatuses to be used after from among the plurality of electronic apparatuses, wherein the at least two electronic apparatuses to be used after includes the electronic apparatus to be used after, and
control, based on the at least two electronic apparatuses to be used after including a pre-set apparatus, the communication interface to transmit to the pre-set apparatus a second control signal.
